(19) United States
(12) Patent Application Publication
(10) Pub. No.: US 2011/0011948 A1
(43) Pub. Date: Jan. 20, 2011

(54) Assembling structure of water conduction device for mist maker

(76) Inventor: Charlie Huang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,516

(22) Filed: Jul. 15, 2009

(51) Int. Cl. B05B 15/00; B05B 13/00

(52) U.S. Cl. 239/44; 239/102.1

(57) ABSTRACT

This invention relates to an assembling structure of water conduction device for mist maker in which the water conduction device comprises a mounting seat and a capillary water-conduction fiber; resilient pieces being provided at both sides of the mounting seat, which have engaging means provided thereon; a mounting hole being further provided within the housing of the mist maker, in which the mounting seat of the water conduction device is assembled, the engaging means provided on the resilient pieces of the mounting seat being interlocked on the wall face of the assembling hole of the housing such that the water conduction device can be mounted within the housing of the mist maker. If the water conduction device is to be replaced, two resilient pieces has to be pressed such that the engaging means are released from the interlocking with the wall face of the assembling hole, then the water conduction device can be detached for replacement.

### BACKGROUND OF THE INVENTION

1. Field of the Invention

This invention relates to an assembling structure of water conduction device for mist maker, particularly to a novel assembling structure of water conduction device for mist maker, wherein a detachable design is employed such that users only replace the water conduction device instead of replacing the whole mist maker so as to avoid wasting resource and raising replacement cost.

2. Brief Description of the Prior Art

The mist maker prevailed on the market has a container provided on the inner bottom for the storage of liquid, and a cotton strip placed in the container. The top end of the mist maker is provided with a supersonic vibrator. One end of the cotton strip is dipped in the liquid, while the other end is in close contact with the supersonic vibrator. Liquid is absorbed by the cotton strip through the capillary action so that the liquid is sucked and delivered to the end with respect to the supersonic vibrator. When the supersonic vibrator is started, the liquid held on the cotton strip is activated by the supersonic vibration so that the molecules of the liquid can become tinier by the vibration so as to generate atomization effect.

The liquid absorption state of the cotton strip plays an important role in association with the result of the atomization effect. Usually, the cotton strip is mounted to be stationary so that it is undetachable. However, the liquid in the mist maker is not necessarily pure water, in some cases it is added with liquid such as flavoring essence. Thus, the water absorption capability of the cotton strip will become deteriorated after a long period of using such that the case of late liquid delivery is apt to occur. At this moment, the supersonic vibrator still keeps on vibrating without any liquid in contact with the supersonic vibrator. Accordingly, this will cause meaningless power loss. In addition, the cotton strip is mounted in the mist maker and the cotton strip itself cannot be replaced alone, unless the whole mist maker is replaced. In fact, the housing and the supersonic vibrator of the mist maker is still usable without any damage. So, throwing away of the housing and the supersonic vibrator in usable condition only for the reason of cotton replacement will cause wasting resource and raising replacement cost.

### SUMMARY OF THE INVENTION

The main object of the present invention is to provide an assembling structure of water conduction device for mist maker, wherein a detachable design is employed such that users only replace the water conduction device instead of replacing the whole mist maker so as to avoid wasting resource and raising replacement cost.

In order to achieve the above object, this invention provides an assembling structure of water conduction device for mist maker in which the water conduction device comprises a mounting seat and a capillary water-conduction fiber; resilient pieces being provided at both sides of the mounting seat, which have engaging means provided thereon; a mounting hole being further provided within the housing of the mist maker, in which the mounting seat of the water conduction device is assembled, the engaging means provided on the resilient pieces of the mounting seat being interlocked on the wall face of the mounting hole of the housing such that the water conduction device can be mounted within the housing of the mist maker.

With this structure, if the water conduction device is to be replaced, two resilient pieces has to be pressed such that the engaging means are released from the interlocking with the wall face of the assembling hole, then the water conduction device can be detached for replacement.

### BRIEF DESCRIPTION OF THE DRAWINGS

FIG. 1 is a perspective exploded view showing the mist maker of the present invention.

FIG. 2 is a sectional front view showing the assembly of the mist maker of the present invention.

FIG. 3 is a sectional schematic view showing that the water conduction device is to be detached.

FIG. 4 is a sectional schematic view after the water conduction device is detached.

### DETAILED DESCRIPTION OF THE PREFERRED EMBODIMENTS

The technical content, objects and effectiveness of the present invention will become more apparent by the detailed description of a preferred embodiment of the present invention in conjunction with the accompanying drawings.

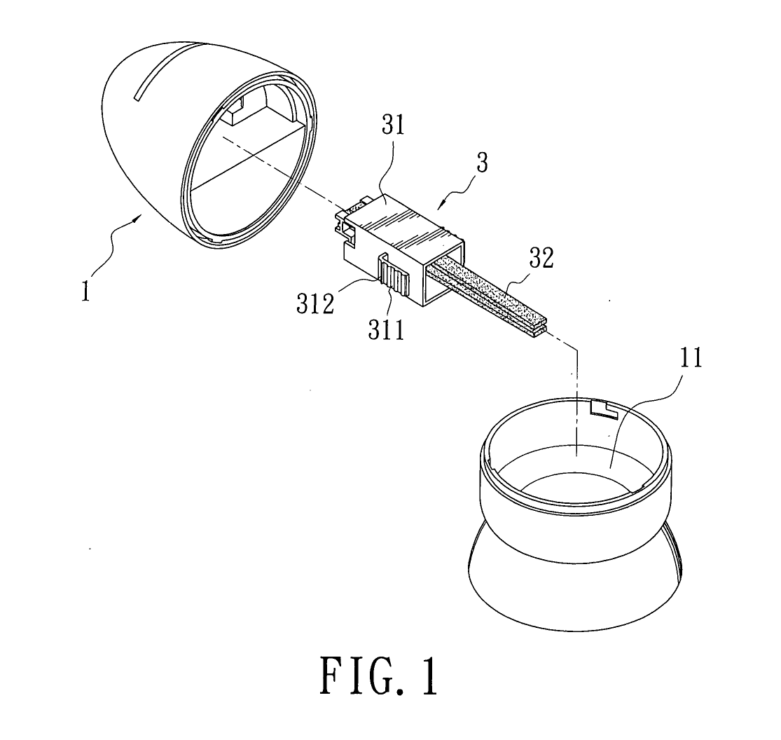

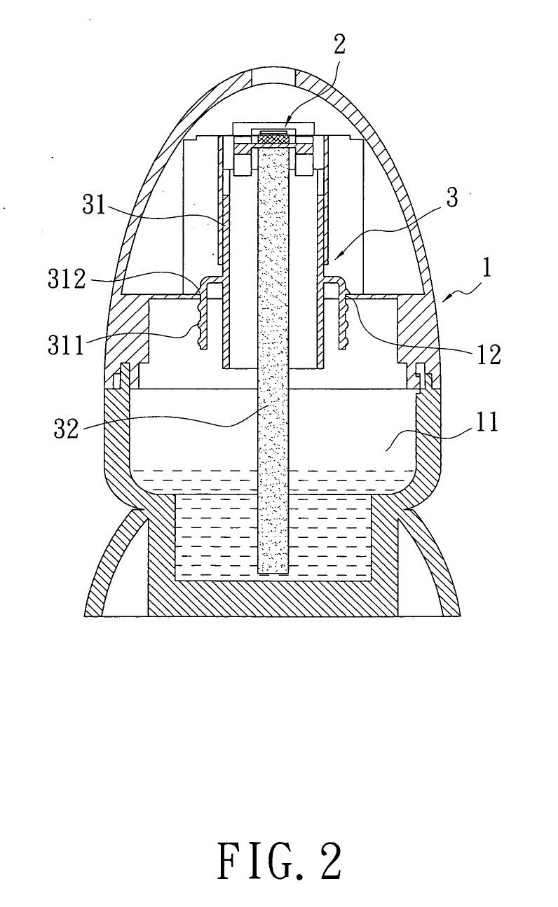

Firstly referring to FIGS. 1 and 2 showing a perspective exploded view and the assembly of the assembling structure of water conduction device for mist maker of the present invention, the mist maker comprises a housing (1), a supersonic vibrator (2) and a water conduction device (3). A container (11) for the storage of liquid is provided on the inner bottom end of the housing (1), while the supersonic vibrator (2) and the water conduction device (3) are installed at the upper end of the housing (1). The water conduction device (3) comprises a mounting seat (31) and a capillary water-conduction fiber (32) mounted on the mounting seat (31). The resilient pieces (311) are provided at both sides of the mounting seat (31), which have engaging means (312) provided thereon. A mounting hole (12) is further provided within the housing (1) of the mist maker, in which the mounting seat (31) of the water conduction device (3) is mounted therein, the engaging means (312) provided on the resilient pieces (311) of the mounting seat (31) are interlocked on the wall face of the mounting hole (12) of the housing (1) such that the water conduction device (3) can be mounted within the housing (1) of the mist maker. At this moment, one end of the capillary water-conduction fiber (32) is dipped in the liquid and the other end is in close contact with the supersonic vibrator (2) such that the liquid is absorbed by the capillary water-conduction fiber (32) through the capillary action, and the liquid thus absorbed is delivered to the one end in contact with the supersonic vibrator (2). When the supersonic vibrator (2) is activated, the liquid held on the capillary water-conduction fiber (32) is subjected to the action of supersonic vibration so that the liquid molecules can become much tinier by the vibration so as to produce atomization effect.

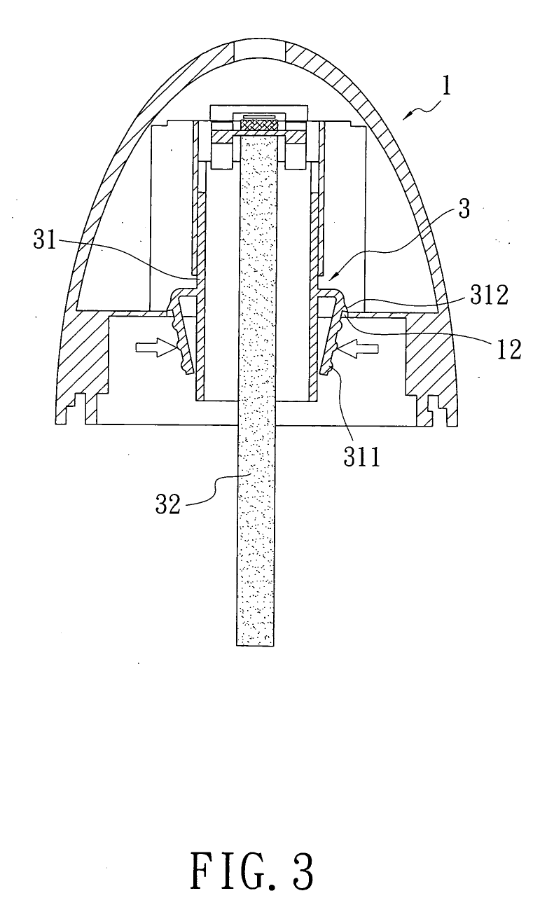

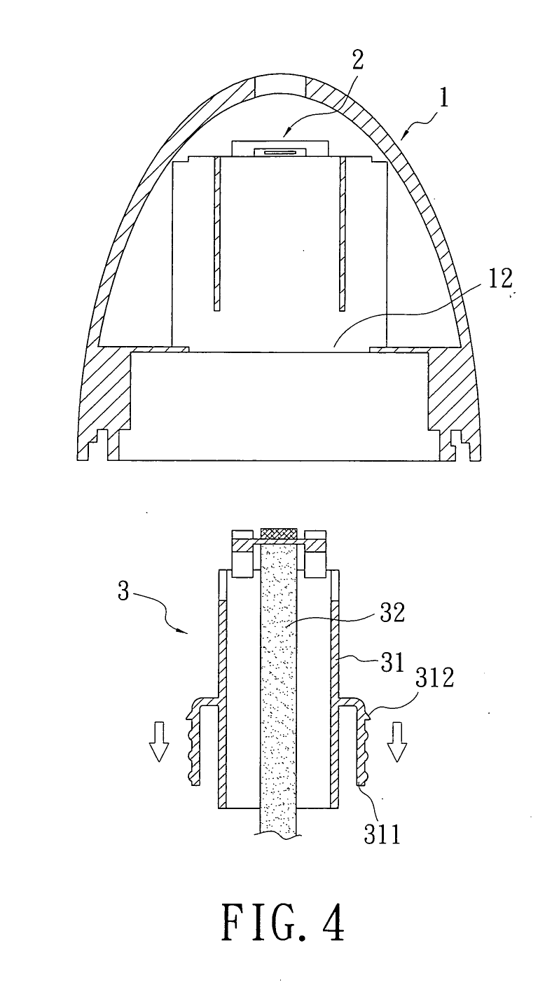

If the liquid absorption capability of the capillary water-conduction fiber (32) becomes deteriorated and even to cause the state of late liquid delivery after being used for a long time, the water conduction device (3) can be detached so as to replace a new one, referring to FIGS. 3 and 4. When the water conduction device (3) is to be detached, the resilient pieces (311) provided at both sides of the mounting seat (31) are directly pressed inward such that the engaging means (312) provided on the resilient pieces (311) are departed from the interlocking with the wall face of the wall surface of the mounting hole (12) of the housing (1). Thus, the water conduction device (3) can be detached smoothly so as to be replaced with a new one.

Based on foregoing description, it is apparent that the water conduction device of the mist maker of the present invention is assembled with a detachable manner within the housing, the water conduction device can be replaced independently without replacing the whole mist maker so as to avoid wasting resource and raising replacement cost.

The above embodiment and drawings are not used to limit the structural aspect of dimension of the present invention. Appropriate variations or modifications without departing from the spirit and features of the present invention are regarded to be still within the scope of the invention.

Summing up above, the embodiment of the present invention is surely able to reach expected effectiveness in application, and the specific structure disclosed herein is not only unprecedented in the same category of product but also not open to the public before application.

What is claimed is:

1. An assembling structure of water conduction device for mist maker, in which the mist maker has a housing for the storage of a liquid therein, a supersonic vibrator and a water conduction device, wherein said water conduction device comprises a mounting seat and a capillary water-conduction fiber; resilient pieces being provided at both sides of the mounting seat, which have engaging means provided thereon; a mounting hole being further provided within the housing of the mist maker, in which the mounting seat of the water conduction device is assembled, the engaging means provided on the resilient pieces of the mounting seat being interlocked on the wall face of the assembling hole of the housing such that the water conduction device can be mounted within the housing of the mist maker; one end of said capillary water-conduction fiber being dipped in the liquid, while the other end being in close contact with the supersonic vibrator.
